(19) United States
(12) Patent Application Publication
(10) Pub. No.: US 2025/0212022 A1
(43) Pub. Date: Jun. 26, 2025

(54) INVERSE BASIC SERVICE SET TRANSITION MANAGEMENT FOR TEMPORAL ROAMING AVOIDANCE

(71) Applicant: Cisco Technology, Inc., San Jose, CA (US)

(72) Inventors: Federico LOVISON, Fontanelle (IT); Jerome HENRY, Pittsboro, NC (US); Indermeet S. GANDHI, San Jose, CA (US); Gino M. CORLETO, Pattensen (DE); Malcolm M. SMITH, Richardson, TX (US); Sukanya NUTAKKI, Frisco, TX (US)

(21) Appl. No.: 18/974,709

(22) Filed: Dec. 9, 2024

Related U.S. Application Data
(60) Provisional application No. 63/614,524, filed on Dec. 23, 2023.

(51) Int. Cl. H04W 24/02; H04W 36/00

(52) U.S. Cl. CPC H04W 24/02; H04W 36/00833

(57) ABSTRACT

Techniques and apparatus for facilitating client roaming within a wireless network are described. An example technique includes determining one or more parameters associated with roaming activity of a client station (STA) within the wireless network. The one or more parameters are evaluated with one or more machine learning (ML) models to determine a mobile classification associated with the client STA and roaming prediction information associated with the client STA. A message including the roaming prediction information and the mobile classification information is transmitted. Another example technique includes generating a message comprising an indication of the roaming prediction information, based at least in part on the mobile classification, and transmitting the message to a client STA.

### CROSS-REFERENCE TO RELATED APPLICATIONS

This application claims benefit of co-pending U.S. provisional patent application Ser. No. 63/614,524 filed Dec. 23, 2023. The aforementioned related patent application is herein incorporated by reference in its entirety.

### TECHNICAL FIELD

Embodiments presented in this disclosure generally relate to wireless communications. More specifically, embodiments disclosed herein relate to systems and techniques for inverse basic service set (BSS) transition management (BTM) for optimizing (or at least improving) client roaming within a wireless network.

### BACKGROUND

In many wireless networks (e.g., wireless local area networks (LANs) (WLANs)), seamless roaming by client stations (STAs) between APs plays a crucial role in ensuring the network and user application performance. Although several extensions to wireless communication standards, such as the Institute of Electrical and Electronics Engineers (IEEE) 802.11 technical standard, have been released to improve roaming by aiding clients, several challenges exist. In particular, in certain cases, the roaming process may be sub-optimal and result in some client STAs performing a roaming process that does not lead to improved wireless performance for the client STA.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIGS. 2A-2C illustrate example client STA roaming scenarios, according to certain embodiments.

FIG. 3 is a flowchart of a method for training a machine learning model(s) to perform inverse BTM for one or more client STAs, according to certain embodiments.

FIG. 4 is a flowchart of a method for performing inverse BTM for one or more client STAs, according to certain embodiments.

FIG. 5 is a flowchart of a method for transmitting roaming prediction information to one or more client STAs within a wireless network, according to certain embodiments.

FIG. 6 is a flowchart of a method for performing roaming based on roaming prediction information, according to certain embodiments.

FIG. 7 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method for facilitating roaming of a client station (STA) within a wireless network. The computer-implemented method includes determining one or more parameters associated with roaming activity of the client STA within the wireless network. The computer-implemented method also includes evaluating the one or more parameters with one or more machine learning (ML) models to determine a mobile classification associated with the client STA and roaming prediction information associated with the client STA. The computer-implemented method further includes transmitting a message comprising the roaming prediction information and the mobile classification.

Another embodiment described herein is a computer-implemented method for facilitating roaming of a client station (STA) within a wireless network. The computer-implemented method includes obtaining an indication of roaming prediction information and a mobile classification associated with the client STA. The computer-implemented method also includes generating a message comprising an indication of the roaming prediction information, based at least in part on the mobile classification, the roaming prediction information comprising an indication of (i) one or more target access points (APs) for the client STA and (ii) for each target AP of the one or more target APs, a likelihood of the client STA returning to a source AP after roaming to the target AP. The computer-implemented further includes transmitting the message to the client STA.

Another embodiment described herein is a computing device. The computing device includes one or more memories collectively storing instructions. The computing device also includes one or more processors communicatively coupled to the one or more memories. The one or more processors are individually or collectively configured to execute the instructions to cause the computing device to perform an operation. The operation includes obtaining an indication of roaming prediction information and a mobile classification associated with a client station (STA). The operation also includes generating a message comprising an indication of the roaming prediction information, based at least in part on the mobile classification, the roaming prediction information comprising an indication of (i) one or more target access points (APs) for the client STA and (ii) for each target AP of the one or more target APs, a likelihood of the client STA returning to a source AP after roaming to the target AP. The operation further includes transmitting the message to the client STA.

### Example Embodiments

Although several extensions to wireless communication standards, such as the IEEE 802.11 technical standard, have been released to improve roaming by aiding clients, one potential drawback to these efforts is that the process of a client STA deciding to dissociate from a source AP and reassociate to a target AP (with preferably a better radio frequency connection as indicated by a stronger received signal strength indicator (RSSI)) is generally controlled by the client STA itself. Consequently, in certain cases, client STAs can make useless roaming decisions in the hope of finding a better AP (with a stronger RSSI) which is often not better enough to be worth the resources dedicated to the roam.

Certain embodiments described herein provide systems, techniques, and apparatus for inverse BTM for optimizing (or at least improving) client roaming within a wireless network. In certain embodiments described herein, the wireless network (e.g., wireless infrastructure including recommender systems, APs, controllers, and client STAs, among other computing systems/devices) can employ artificial intelligence (AI)/machine learning (ML) techniques to guide (e.g., inform) the client STA on which AP (e.g., optimal AP in terms of one or more metrics) to associate to and stay associated to, along with which AP not to roam to within the wireless network.

Advantageously, the techniques described herein can significantly improve the communication performance (e.g., increased throughput, lower latency, lower interference, etc.) of client STAs within a wireless network by mitigating the amount of temporal roaming of client STAs within the wireless network. For example, the AI/ML techniques herein can help a STA renounce (or rescind or revoke or avoid) roaming decisions when the wireless network (or one or more components thereof) predicts that a likelihood of a roam (from the client STA's radio frequency (RF) position) is greater than (or equal to) a (first) threshold, but the likelihood of the roam resulting in improved performance for the client STA is below a (second) threshold.

Although the terms “first,” “second,” “third,” etc., may be used herein to describe various devices, circuits, elements, components, regions, layers and/or sections, these devices, circuits, elements, components, regions, layers and/or sections should not be limited by these terms. These terms may be only used to distinguish one device, circuit, element, component, region, layer or section from another device, circuit, element, component, region, layer, or section. Terms such as “first,” “second,” and other numerical terms, when used herein, do not imply a sequence or order unless clearly indicated by the context. Thus, a “first” device, circuit, element, component, region, layer, or section discussed herein could be termed a “second” device, circuit, element, component, region, layer, or section without departing from various embodiments described herein.

Note, the techniques described herein for optimizing (or at least improving) client roaming within a wireless network using inverse BTM may be incorporated into (such as implemented within or performed by) a variety of wired apparatuses (or nodes), wireless apparatuses (or nodes), or a combination thereof. A wireless node may provide, for example, connectivity to or from a network (such as a wide area network (WAN) such as the Internet or a cellular network) via a wired or wireless communication link. In some implementations, a wireless node may include a computing system (e.g., server), a controller, or an AP.

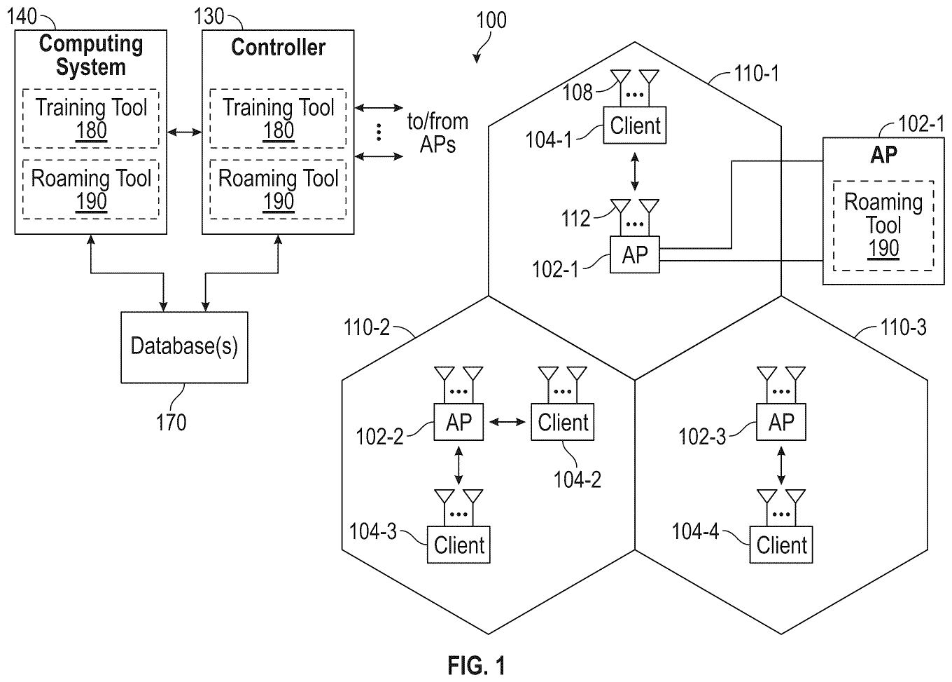

FIG. 1 illustrates an example system in which one or more techniques described herein can be implemented, according to certain embodiments. As shown, the system 100 includes, without limitation, one or more APs (e.g., AP 102-1, AP 102-2, and AP 102-3), one or more client STAs (e.g., client STA 104-1, client STA 104-2, client STA 104-3, and client STA 104-4), a controller 130, a computing system 140, and one or more databases 170.

An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a BSS. Here, BSS 110-1 includes AP 102-1 and client STA 104-1 served by AP 102-1, BSS 110-2 includes AP 102-2 and client STAs 104-2 and 104-3 served by AP 102-2, and BSS 110-3 includes AP 102-3 and client STA 104-4 served by AP 102-3. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104 and/or one or more APs 102. In general, the AP(s) 102 and the client STA(s) 104 may form any suitable number of links for communication using any suitable frequencies and using any suitable communication protocols.

In some instances, a client STA 104 may form multiple links with a single AP 102. For example, a client STA 104-1 can use a first radio 108-1 operating on a first band (e.g., 5 GHz band) to establish a first link 150-1 with AP 102-1, a second radio 108-2 operating on a second band (e.g., 6 GHz band) to establish a second link 150-2 with the AP 102-1, a third radio 108-3 operating on a third band (e.g., 2.4 GHz band) to establish a third link 150-3 with the AP 102-1, and so on.

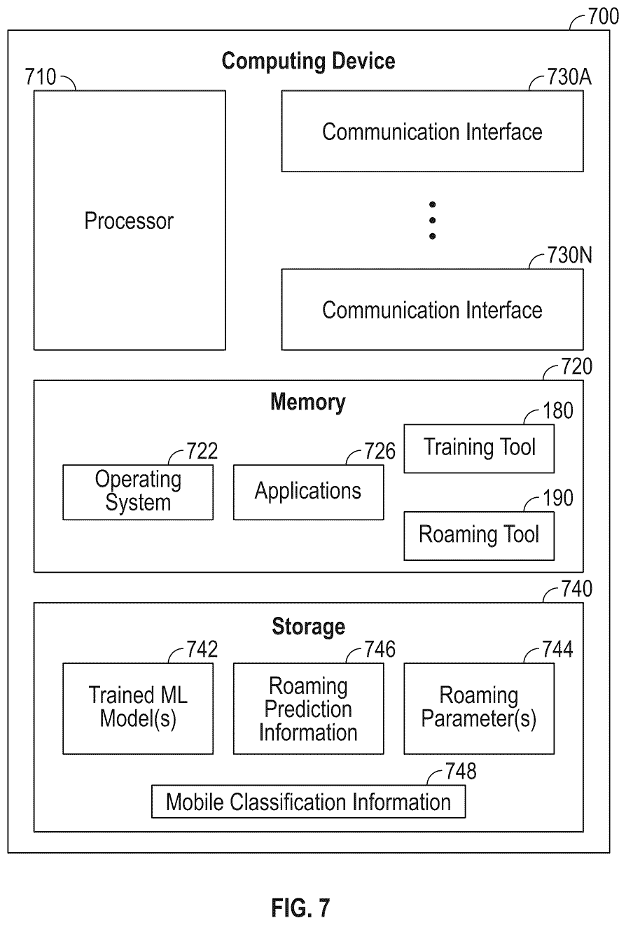

In some instances, a client STA may form multiple links 150 across multiple APs 102. For example, a client STA 104-1 can use a first radio 108-1 operating on a first band (e.g., 5 GHz band) to establish a first link with AP 102-1 and use a second radio 108-2 operating on a second band (e.g., 6 GHz band) to establish a second link with AP 102-2. In general, each client STA 104 may establish multiple communication links across one or more APs 102. Similarly, each AP 102 may establish multiple communication links across one or more client STAs 104. Example hardware that may be included in a client STA is discussed in greater detail in regard to FIG. 7.

The operations of the controller 130 may be implemented by any device or system, and may be combined or distributed across any number of systems. For example, the controller 130 may be a WLAN controller for the APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. Example hardware that may be included in a controller 130 or AP 102 is discussed in greater detail with regard to FIG. 7.

The database(s) 170 are representative of storage systems that may include historical and/or real-time information associated with (i) roaming messages (e.g., probe requests/responses, authentication requests/responses, etc.) exchanged between client STAs 104 and APs 102 in the network, (ii) beacon messages from APs 102 in the network, (iii) neighbor reports, (iv) neighbor discovery protocol (NDP) messages, (v) signal strength measurements of messages received at APs 102 (e.g., RSSI/signal-to-interference-plus-noise ratio (SINR)/channel state information (CSI) of a last frame from a client STA on AP 102-1, and RSSI/SINR/CSI of an initial frame from the client STA on AP 102-2); (vi) roaming stability of one or more client STAs 104 (e.g., for a given client STA, an indication of how long the client STA stays associated with an AP after associating with that AP), (vii) radio resource configurations (e.g., AP maximum transmit powers), (viii) AP parameters (e.g., quality of service (QoS) basic service set (BSS) (QBSS) load, AP power, AP operating channel, etc.), (ix) radio resource management (RRM) information, (x) logic (e.g., trained ML models) for predicting client roaming and/or client STA performance after roaming, (xi) client STA types (e.g., device ecosystem analytics), (xii) AP topological information (e.g., AP positions), or (xiii) any combination thereof.

Note, that in certain embodiments, one or more of the client STAs 104 may be referred to as STA multi-link devices (MLDs) (e.g., a STA or client device acting as a MLD) and/or one or more of the APs 102 may be referred to as AP MLDs (e.g., an AP that acts as a MLD). The STA MLD and AP MLD are generally representative of any device capable of performing multi-link operations.

A MLD (e.g., STA MLD or AP MLD) generally provides a unique MAC instance to multiple wireless interfaces (e.g., wireless channels). The MLD may include a logical link control (LLC) layer and an upper MAC (U-MAC) layer. The upper MAC layer is a common part of the MAC sub-layer for all the interfaces. The MLD also includes a respective lower MAC (L-MAC) for each interface. Each respective L-MAC manages a corresponding PHY layer as well as link specific functionalities (e.g., channel access) for the corresponding wireless channel.

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

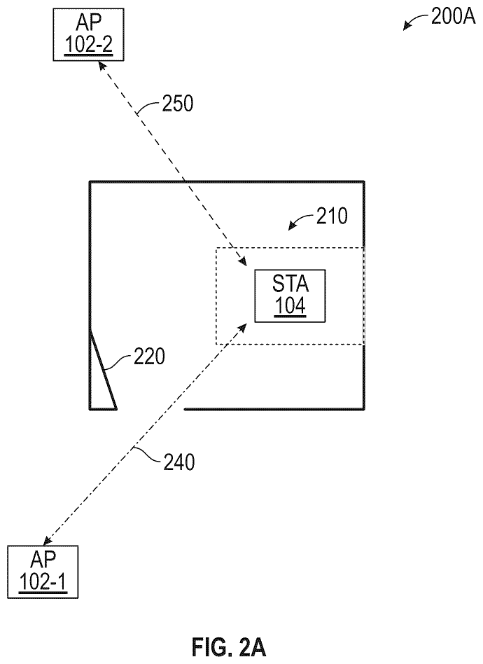

As noted, in certain cases, a client STA may make “useless” roaming decisions that can impact the performance of the client STA in terms of reduced throughput, increased latency, and lower transmission range, as illustrative examples. While roaming may be envisioned as a client STA performing a physical linear motion crossing of two AP cells, in many instances, roaming is also a temporal event affecting a static or pacing client STA. Consider an example scenario in FIG. 2A, which illustrates an example system 200A including, without limitation, a client STA 104 (e.g., teleconferencing unit), a first AP 102-1 and a second AP 102-2. In FIG. 2A, the client STA 104 is located within a room 210 (e.g., meeting room), and the first AP 102-1 and the second AP 102-2 are located outside of the room 210.

In the scenario depicted in FIG. 2A, the client STA 104 may associate to the first AP 102-1 via communication link 240 when the door 220 to the room 210 is open (e.g., the room 210 may be unused) and the client STA 104 has a line of sight (LOS) to the first AP 102-2 through the open door 220. However, when the door 220 is closed (e.g., a user may start a teleconference call using client STA 104), the signal from the first AP 102-1 at the client STA 104 may become marginal, triggering the client STA 104 to scan for a better AP (with preferably stronger RSSI).

As shown in FIG. 2A, as a result of the scan, the client STA 104 may discover the second AP 102-2 and associate to the second AP 102-2 via communication link 250. The client STA 104 may discover the second AP 102-2 at an acceptable RSSI level, but slightly below (within a threshold range of) the client STA's roaming threshold (e.g., the client STA 104 may start roaming at −67 decibels per milliwatt (dBm) and the RSSI of the second AP 102-2 may be approximately −70 dBm). The client STA 104 may continue scanning in the background. At intervals, the door 220 may open (e.g., someone walks in/out of the meeting room), triggering the client STA 104 to immediately roam back to the first AP 102, and then back to the second AP 102-2 as the door 220 closes again.

Consider another example scenario in FIG. 2B, which illustrates an example system 200B including, without limitation, a client STA 104 (e.g., laptop), a first AP 102-1 and a second AP 102-2. In FIG. 2B, the client STA 104 is located on a desk 230. In certain cases, when the user 232 is not sitting in front of the desk 230, the client STA 104 may have LOS to the first AP 102-1 and may be associated to the first AP 102-1 via communication link 242. When the user 232 is sitting in front of the desk 230, the user 232 may obscure the LOS between the client STA 104 and the first AP 102-1, prompting the client STA 104 to scan for a better AP (with preferably stronger RSSI).

As shown in FIG. 2B, as a result of the scan, the client STA 104 may discover the second AP 102-2 (behind wall 234) and associate to the second AP 102-2 via communication link 250. The client STA 104 may discover the second AP 102-2 at an acceptable RSSI level, but slightly below (within a threshold range of) the client STA's roaming threshold (e.g., the client STA 104 may start roaming at −67 dBm and the RSSI of the second AP 102-2 may be approximately −70 dBm). The client STA 104 may continue scanning in the background. At intervals, as the user 232 moves in front of the desk 230, the client STA 104 may go back and forth between roaming to the first AP 102-1 and roaming to the second AP 102-2.

Consider yet another example scenario in FIG. 2C, which illustrates an example system 200C including, without limitation, a client STA 104 (e.g., laptop), a first AP 102-1 and a second AP 102-2. In FIG. 2C, the first AP 102-1 may be located in a first room 262 (e.g., conference venue A), the second AP 102-2 may be located in a second room 264 (e.g., conference venue B), and the client STA 104 (e.g., smartphone) may be located in a hallway 266 between the first room 262 and the second room 264.

In FIG. 2C, a user may use the client STA 104 to place a phone call in the hallway 266 and may pace back and forth between location A and location B. In some cases, as the user turns, the user's body may interfere with the signal from the first AP 102-1, triggering the client STA 104 to roam to the second AP 102-2. Likewise, in some cases, as the user turns, the user's body may interfere with the signal from the second AP 102-2, triggering the client STA 104 to roam to the first AP 102-1.

In the scenarios depicted in FIGS. 2A-2C, the client STA 104 may make a useless roaming decision. That is, the client STA 104 may consume resources (time as well as compute resources) in the hope of finding a better AP that is not going to be “better enough” (in terms of one or more metrics, such as signal strength, latency, among others) to be worth the roam. In the aforementioned scenarios, the client STA may not have a mechanism to pick and stay on the “best” AP in terms of one or more performance metrics.

Certain embodiments described herein provide techniques for using AI/ML techniques for inverse BTM to optimize (or at least improve) client roaming within a wireless network, such as system 100. Referring back to FIG. 1, the computing system 140 includes a training tool 180 and a roaming tool 190, each of which is configured to implement one or more techniques described herein. Note that while the training tool 180 and roaming tool 190 are depicted within a single computing system 140, the training tool 180 and roaming tool 190 may be implemented by one or more computing systems distributed across a cloud computing environment. Additionally, note that while the training tool 180 and roaming tool 190 are depicted as separate components, in certain embodiments, the training tool 180 and roaming tool 190 may be implemented by a single component. In certain embodiments, one or more of the operations of the training tool 180 and/or the roaming tool 190 may be performed by an AP 102. In certain embodiments, one or more of the operations of the training tool 180 and/or the roaming tool 190 may be performed by a controller 130. The training tool 180 and the roaming tool 190 may include hardware, software, or combinations thereof.

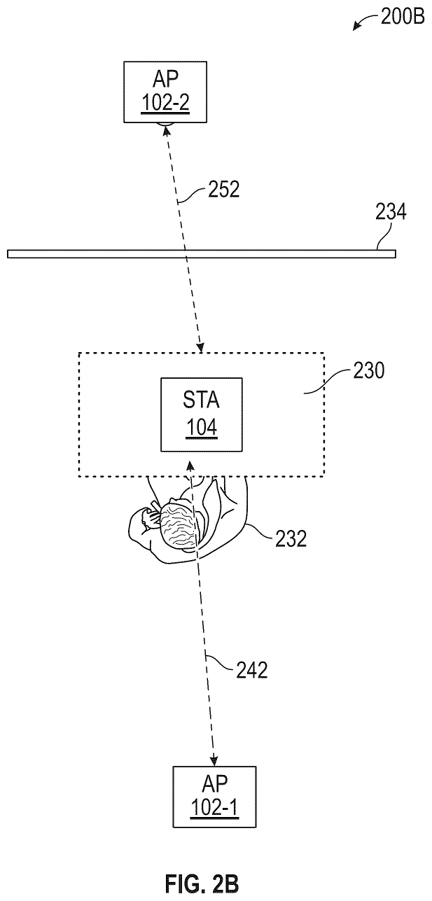

In certain embodiments, the training tool 180 may train one or more ML models to perform inverse BTM. For example, the ML model(s) may be trained to predict which AP the client STA should associate to and stay associated to, along with which AP the client STA should not roam to. FIG. 3 is a flowchart of a method 300 for training an ML model to perform inverse BTM, according to certain embodiments. The method 300 may be performed by a training tool, such as training tool 180.

Method 300 may enter at block 305, where the training tool monitors roaming activity of one or more client STAs (e.g., client STA(s) 104) in a wireless network (e.g., system 100), e.g., via the controller (e.g., controller 130) and/or one or more APs (e.g., APs 102). In certain examples, the training tool may monitor, via the controller and/or APs, probe requests sent by client STAs to APs, beacon messages from APs, neighbor reports from APs, roaming stability of client STAs, AP(s) parameters, client STA(s) parameters, client STA types, or any combination thereof.

At block 310, the training tool generates a dataset based on the monitoring. The dataset may include a set of information collected (or retrieved) from the controller, one or more AP(s), one or more databases (e.g., database(s) 170), or a combination thereof. The generated dataset may include one or more parameters associated with roaming activity of the client STAs(s), one or more AP(s) parameters, one or more client STA(s) parameters, client STA types, or any combination thereof.

In certain examples, the training tool (at block 310) may generate the dataset, in part, by obtaining, from each AP, the media access control (MAC) address of each associated client STA to the AP, one or more parameters indicative of each associated client STA's activity (e.g., RSSI, modulation and coding scheme (MCS), uplink/downlink (UL/DL) volume for each access category (AC) over each target interval), signal strength (e.g., RSSI) of probe requests, when the client STA can be identified (e.g., associated client STA using its stable MAC to probe, randomized and changing MAC (RCM) in a low density scenario where the mapping to client STA is possible, etc.), beacon reports (from the client STAs), or any combination thereof. In certain examples, each AP may query its associated client STAs for their respective beacon reports in order to obtain an indication of the client's STA's view of the RF environment for current and neighboring APs. Each AP may report the aforementioned information (or any subset thereof) to the training tool.

Additionally or alternatively, in certain examples, the training tool (at block 310) may generate the dataset, in part, by determining the roaming stability of each client STA in the network and including the roaming stability information in the dataset. The roaming stability of a client STA may be represented by the amount of time the client STA stays connected with an AP after associating with that AP. Here, the training tool may obtain the roaming stability information from the controller and/or the AP(s). For example, the training tool may obtain an index (from the controller and/or a given AP) indicating (i) whether a client STA sent an authentication request to the AP after probing for the AP and (ii) if the client STA associated with the AP, an amount of time that the client STA was connected to the AP. In addition to the roaming stability information, the training tool may query each AP for one or more AP parameters, such as QBSS load, AP power and operating channel, as illustrative, non-limiting examples, and include the AP parameters in the dataset.

Additionally or alternatively, in certain examples, the training tool may generate (at block 310) the dataset, in part, by determining each type of each client STA in the wireless network, and including the client STA type information in the dataset. The training tool may obtain the client STA type information from the controller and/or AP(s). The client STA type information may indicate, for a given client STA, the device OEM, device OS type and version, and device capabilities, as illustrative, non-limiting examples. In certain embodiments, the training tool may correlate other roaming information obtained via the controller and/or APs based on the client STA types. For example, the training tool may create (and include within the dataset) a first group of roaming parameters for a first type of client STAs, create a second group of roaming parameters for a second type of client STAs, and so on.

At block 315, the training tool trains a ML model(s) with the dataset to perform inverse BTM for the client STAs. The training tool may employ various AI/ML techniques to predict the probability of several types of behaviors.

In certain examples, the training tool may train a ML model to predict, for a given client STA, the probability (or likelihood) that the client STA is a static client STA (e.g. a teleconference unit in a meeting room). The ML model can be a Bayesian or linear regressor, which is trained based on the history of RSSI and MCS on associated APs for that client STA over the last n time intervals. The probability that a client STA is a static client STA may increase as n increases.

Additionally or alternatively, in certain examples, the training tool may train a ML model to predict, for a given client STA, the next likely roaming AP for the client STA. In addition to predicting the next likely roaming AP, the training tool can train the ML model to predict the probability (or likelihood) of the client STA returning back to the previous AP (assuming the client STA roams to the next likely AP). Here, the ML model can use Gini impurity and a random tree, based on the prediction of the next AP.

Additionally or alternatively, in certain examples, the training tool may train a ML model to predict, for a given AP, the probability (or likelihood) of the AP being a “transient hostel” AP. As used herein, a “transient hostel” AP may refer to an AP to which client STAs (i) briefly associate (before roaming to another AP) or (ii) associate with longer sessions, but significant client traffic is generally present on other APs (to which the client STAs roam when significant traffic is exchanged). Significant traffic may be expressed in volume or as a combination of volume and AC.

Additionally or alternatively, in certain examples, the training tool may train a ML model to predict, for each returning client STA that is predicted by the ML model described above, the probability (or likelihood) of a successful communication session on the source AP without roaming to the target AP. For example, given the STA's RSSI/MCS at the edge of the source AP, the STA's RSSI/MCS upon roaming to the target AP, the UL/DL profiles on the source AP and target AP, and session duration on the target AP, the ML model may predict the likelihood that a continued session on the source AP would have been successful according to one or more performance metrics (e.g., the STA would have successfully exchanged traffic with performances equivalent to that measured on the target AP).

At block 320, the training tool stores the ML model in a storage system and/or provides the ML model to a computing system. For example, as described in greater detail herein, a roaming tool (e.g., roaming tool 190) may obtain and utilize the trained ML model(s) to perform inverse BTM to facilitate client roaming in the wireless network.

Note that the training tool may use any suitable artificial intelligence (AI)/ML technique to train the ML model (e.g., at block 315). Such techniques may include gradient boosting trees, logistic regression, support vector machines, random forest algorithms, k-nearest neighbors algorithm (k-NN), deep-learning algorithms, and adaptive boosting, as illustrative, non-limiting examples. In certain embodiments, the training tool may train the ML model offline (referred to as offline machine learning or batch learning). For example, the training tool may monitor the roaming activity of one or more client STAs over a period of time (e.g., minute(s), hour(s), day(s), or some other period of time) (block 305), generate a dataset based on the monitoring for the period of time (block 310), and train the ML model offline based on the dataset (block 315). In certain embodiments, the training tool may train the ML model online (referred to as online machine learning). For example, the training tool may train the ML model online (e.g., in real-time) as data, based on the operations in block 305 and 310, becomes available. Training the ML model online may allow the training tool to adapt to rapidly changing conditions in the wireless network. In certain embodiments, the training tool may train the ML model offline and online. For example, the training tool may train an ML model offline based on historical data associated with roaming activity of client STAs in one or more first wireless networks, and train the ML model online based on real-time data associated with roaming activity of client STAs in a second (current) wireless network.

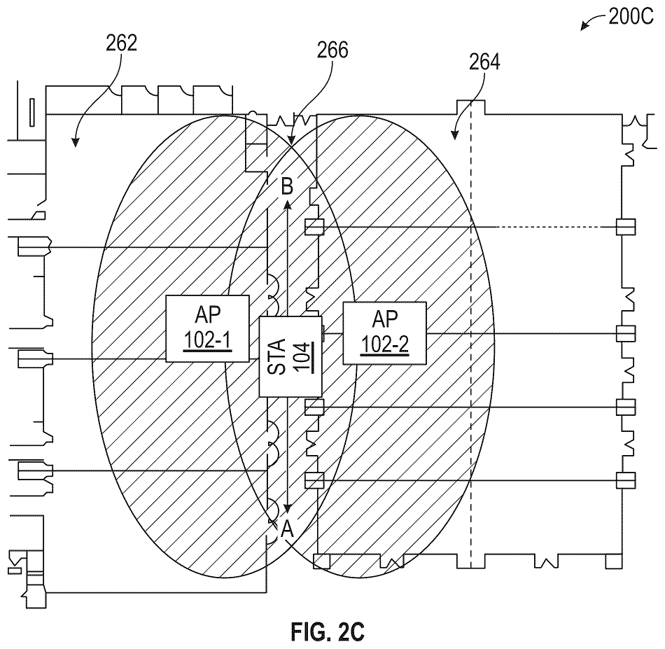

FIG. 4 is a flowchart of a method 400 for performing inverse BTM, according to certain embodiments. The method 400 may be performed by a roaming tool, such as roaming tool 190.

Method 400 may enter at block 405, where the roaming tool determines one or more parameters associated with roaming activity of one or more client STAs (e.g., client STA(s) 104) in a wireless network (e.g., system 100). The parameters, for example, may include any combination of the aforementioned information that is obtained and/or reported to the training tool 180.

At block 410, the roaming tool evaluates the one or more parameters with one or more trained ML models (e.g., the trained ML model(s) generated in FIG. 3) to determine a mobile classification for each client STA in the network and roaming prediction information. For example, the roaming tool may use the trained ML model(s) to classify each respective client STA in one of three categories: (i) static client STAs, (ii) pacing client STAs (between two or more cells, in a measurable sequence), and (iii) mobile client STAs (e.g., STAs moving between APs without a predictable returning pattern). The roaming prediction information may include an indication of (i) the “best” AP for the client STA to associate with, and stay associated with, within the network, (ii) the AP(s) the client STA should not roam to within the network, or (iii) a combination thereof. As used herein, the “best” AP may be the AP to which the client STA could associate to and stay associated for a predefined amount of time—without roaming—with optimal performance (e.g., one or more performance metrics being satisfying one or more respective thresholds).

At block 415, the roaming tool transmits a message comprising the respective roaming prediction information and respective mobile classification for each client STA. In certain examples, the roaming tool may transmit an indication of the respective roaming information for each client STA to each AP within the network. For example, for a given client STA, the roaming tool may inform (i) target AP(s), (ii) source AP(s), and (iii) AP(s) to which the STA roams without sufficient performance benefit, about the roaming prediction information for the client STA.

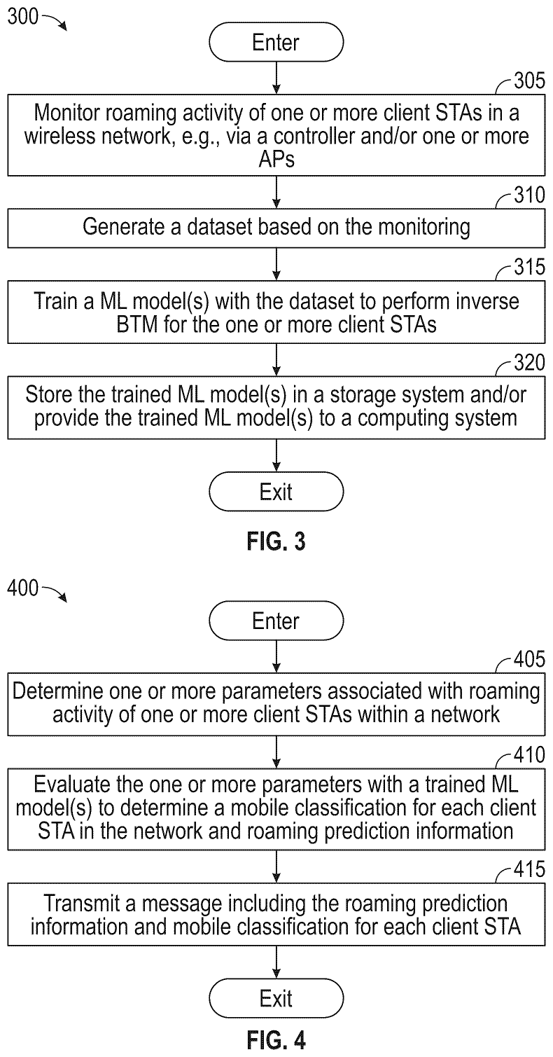

FIG. 5 is a flowchart of a method 500 for transmitting roaming prediction information to one or more client STAs within a wireless network, according to certain embodiments. The method 500 may be performed, for example; by an AP(s) (e.g., AP(s) 102).

Method 500 enters at block 505, where an AP (e.g., source AP) obtains roaming prediction information and a mobile classification associated with a client STA. The mobile classification may indicate, for example, whether the client STA is a static client STA, a pacing client STA, or a mobile client STA. Note, the AP may continually obtain (updated) roaming prediction information and (updated) mobile classification for the client STA over time (e.g., as the client STA roams or is operating within the network).

At bock 510, the AP generates and transmits a negative BTM (nBTM) frame (also referred to as an inverse BTM frame or inverted BTM frame) including at least a portion of the roaming prediction information, based at least in part on the mobile classification.

For example, assuming the client is a static client or a pacing client operating in a small geographical zone (where the source AP's coverage is sufficient to maintain performance at or above one or more threshold metrics), the negative BTM frame may include an indication of one or more target APs (or a list of target APs) along with an indication of a respective channel and BSSID for each target AP. In certain embodiments, the negative BTM frame may further include (i) an indication of the source AP's BSSID/channel and (ii) for each target AP, the likelihood of returning to the source AP along with the predicted mean return delay. The negative BTM frame may be regenerated each time that the STA's RSSI changes by a predetermined level or amount, which may be configurable.

Note, in certain cases, there may be scenarios where the client STA does not process the aforementioned negative BTM frame. For example, the client STA may not have received the negative BTM frame due to a communication error, delay (or latency), interference, etc. In such cases, the client STA may roam to a target AP without consideration of the roaming prediction information for that client STA. In these cases, in certain embodiments, the target AP may generate and transmit an augmented BTM frame that indicates the source AP's target BSSID/channel as well as, for each target AP determined for the client STA, the likelihood of the client STA returning to the source AP along with the predicted mean return delay.

In certain examples, assuming the client STA is identified as a mobile STA or a pacing STA along a path cycle where a single cell is insufficient, the AP may modify the negative BTM frame described herein to generate a roaming negative BTM frame. The roaming negative BTM frame may include the next “best” AP BSSID/channel, the likelihood of roaming to that next “best” AP and, for each neighboring AP, the likelihood of returning to the next “best” AP along with the likely mean return delay. In certain embodiments, the roaming negative BTM frame may be updated as the client STA moves along its roaming path.

In certain examples, assuming the client STA is identified as a mobile STA or a pacing STA along a path cycle where a single cell is insufficient, the AP may modify the negative BTM frame described herein to generate a path BTM frame. The path BTM frame may include the information included within the roaming negative BTM frame (e.g., the next “best” AP) along with information associated with one or more other next “best” APs. For example, the path BTM frame may indicate a first next “best” AP, the second next “best” AP after the first next “best” AP, and so on, given the predicted client STA's path. For each next “best” AP, the path BTM frame may include similar probability information as the roaming negative BTM frame.

Advantageously, the negative BTM frames, roaming negative BTM frames, and path BTM frames described herein may allow a client STA to avoid roaming to an AP that would be for a limited period of time (e.g., below a threshold) and offer performance that is below a threshold performance (e.g., offers no clear advantage over staying on an AP that may seem to offer less than optimal performance, but which performances would match the AP that the client STA is tempted to roam to).

Certain embodiments described herein also provide techniques for facilitating client roaming within a wireless network by providing the client STA with a roaming MLD temporal transient neighbor list.

For example, in certain embodiments, the client STA may be a MLD (e.g., STA MLD) and may use one of its radios (e.g., eMLSR Rx-only) to scan for new APs. Additionally, in certain embodiments, a source AP (e.g., AP 102) may learn of the client STA's transient connectivity with respect to certain APs or AP-STA pairs. The source AP may advertise this transient behavior for the neighbor APs and recommended dwell time along with the RSSI threshold in one or more neighbor reports.

The client STA may use the dwell time and transient status of a candidate AP to perform an extended scan with a secondary “SCAN” radio. After scanning/monitoring of a transient AP for a predetermined period of time (e.g., 5 seconds or some other amount of time), the client STA can decide to switch to, or to refrain from switching to, the target AP (MLD).

In certain embodiments, the source AP may learn the transient nature of the AP-STA connectivity (e.g., a measure of stickiness) using any suitable time-series evolution technique, such as Markov prediction model, recurrent neural network (RNN), among others. Instead of solely predicting the final AP with a certain probability, the techniques described herein can determine the amount of time (or time steps) (e.g., 100 milliseconds (ms)) after roaming to the target AP that the original AP is re-selected (e.g., transient nature of the target AP).

In particular, the AP can use a trained ML model to identify target AP-STA pairs (e.g., via decision tree/forest) that are predominantly transient from the point of view of the client STA. The AP can provide, to the client STA, client-specific neighbor reports that indicate the target AP's transient status and the recommended dwell or monitor time with RSSI threshold (from the decision tree). This temporal rating (e.g., selection lifetime=10 seconds) allows the client STA to decide whether the client STA should re-associate or stay on the current AP.

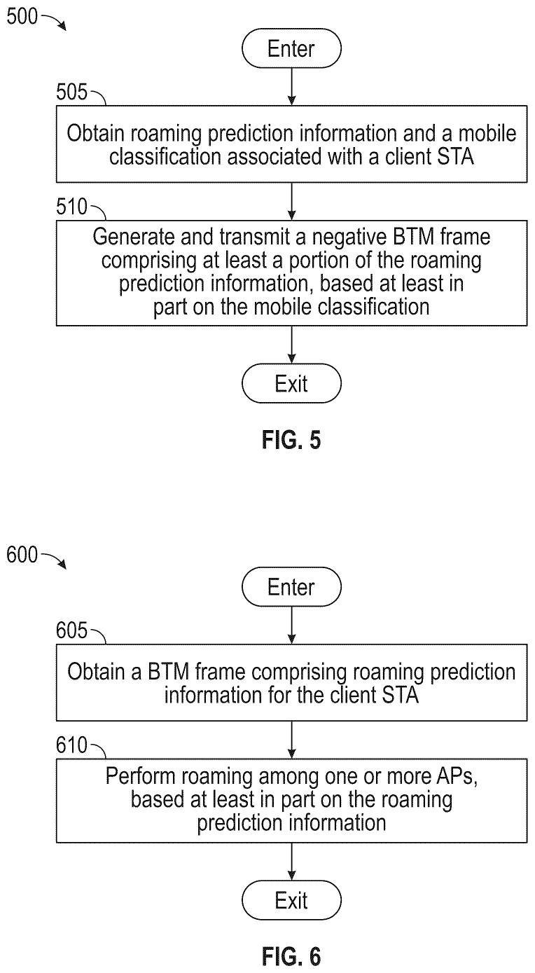

FIG. 6 is a flowchart of a method 600 for performing roaming based on roaming prediction information, according to certain embodiments. The method 600 may be performed by a client STA (e.g., client STA 104).

Method 600 may enter at block 605, where the client STA obtains a BTM frame including roaming prediction information for the client STA. In certain embodiments, the BTM frame is a negative BTM frame. In other embodiments, the BTM frame is a roaming negative BTM frame. In yet other embodiments, the BTM frame is a path BTM frame. In certain embodiments, the roaming prediction frame may include one or more neighbor reports indicating, for each neighbor AP, the neighbor AP's transient status and the recommended dwell or monitor time with RSSI threshold.

At block 610, the client STA performs roaming among one or more APs, based at least in part on the roaming prediction information. In certain embodiments, for example, the client STA may revoke or renounce a decision to roam to a particular target AP, based on the roaming prediction information. In certain embodiments, the client STA may determine the “best” AP to associate to, and stay associated to, based on the roaming prediction information, and may roam to the determined “best” AP.

FIG. 7 illustrates an example computing device 700, according to one embodiment. The computing device 700 can be configured to perform one or more techniques described herein for inverse BTM. For example, the computing device 700 can perform method 300, method 400, method 500, method 600, and any other techniques (or combination of techniques) described herein. The computing device 700 may be representative of a controller (e.g., controller 130), a computing system (e.g., computing system 140), a network entity (e.g., an AP, such as AP 102), or a client STA (e.g., client STA 104). The computing device 700 includes, without limitation, a processor 710, a memory 720, one or more communication interfaces 730a-n. In one example, a communication interface 730 includes a radio.

The processor 710 may be any processing element capable of performing the functions described herein. The processor 710 represents a single processor, multiple processors, a processor with multiple cores, and combinations thereof. The communication interfaces 730 (e.g., radios) facilitate communications between the computing device 700 and other devices. The communications interfaces 730 may include wireless communications antennas and various wired communication ports.

The memory 720 may be either volatile or non-volatile memory and may include RAM, flash, cache, disk drives, and other computer readable memory storage devices. Although shown as a single entity, the memory 720 may be divided into different memory storage elements such as RAM and one or more hard disk drives. As shown, the memory 720 includes various instructions that are executable by the processor 710 to provide an operating system 722 to manage various functions of the computing device 700. The memory 720 also includes a training tool 180, a roaming tool 190, and one or more application(s) 726.

The computing device 700 may include storage 740. In some cases, the storage 740 may be a disk drive or flash storage device. In some cases, the storage 740 may be a combination of fixed and/or removable storage devices, such as fixed disc drives, solid state drives, removable memory cards, optical storage, network attached storage (NAS), or a storage area-network (SAN). The storage 740 may include a trained ML model(s) 742, roaming prediction information 746, roaming parameter(s) 744, mobile classification information 748, or any combination thereof, as illustrative, non-limiting examples.

### EXAMPLE CLAUSES

Implementation examples are described in the following numbered clauses:

Clause 1: A computer-implemented method for facilitating roaming of a client station (STA) within a wireless network, the computer-implemented method comprising: determining one or more parameters associated with roaming activity of the client STA within the wireless network; evaluating the one or more parameters with one or more machine learning (ML) models to determine a mobile classification associated with the client STA and roaming prediction information associated with the client STA; and transmitting a message comprising the roaming prediction information and the mobile classification.

Clause 2: The computer-implemented method of Clause 1, wherein the mobile classification indicates that the client STA is (i) a static client STA, (ii) a pacing client STA with a predictable pattern, or (iii) a mobile client STA lacking a predictable pattern.

Clause 3: The computer-implemented method according to any of Clauses 1-2, wherein the one or more parameters comprise at least one of a signal strength of the client STA, a modulation and coding scheme (MCS) used at the client STA, traffic volume for one or more access categories (ACs), signal strength of probe requests, beacon reports, or any combination thereof.

Clause 4: The computer-implemented method according to any of Clauses 1-3, wherein the one or more ML models comprises a ML model trained to predict a likelihood that the client STA is a static client STA.

Clause 5: The computer-implemented method according to any of Clauses 1-4, wherein the one or more ML models comprises a ML model trained to predict a target access point (AP) for the client STA and a likelihood of the client STA returning to a previous source AP after roaming to the target AP.

Clause 6: The computer-implemented method according to any of Clauses 1-5, wherein the one or more ML models comprises a ML model trained to predict, for at least one access point (AP) within the wireless network, a likelihood of the AP being a transient AP.

Clause 7: The computer-implemented method according to any of Clauses 1-6, wherein the one or more ML models comprises a ML model trained to predict, for the client STA, a likelihood of a successful communication session with a source access point (AP) without roaming to a target AP.

Clause 8: The computer-implemented method according to any of Clauses 1-7, wherein the roaming prediction information comprises an indication of (i) a target access point (AP) for the client STA to associate with within the wireless network and (ii) an indication of one or more other APs that the client STA should avoid roaming to within the wireless network.

Clause 9: The computer-implemented method of Clause 8, wherein the target AP is associated with a predefined level of performance for a predetermined amount of time.

Clause 10: A computer-implemented method for facilitating roaming of a client station (STA) within a wireless network, the computer-implemented method comprising: obtaining an indication of roaming prediction information and a mobile classification associated with the client STA; generating a message comprising an indication of the roaming prediction information, based at least in part on the mobile classification, the roaming prediction information comprising an indication of (i) one or more target access points (APs) for the client STA and (ii) for each target AP of the one or more target APs, a likelihood of the client STA returning to a source AP after roaming to the target AP; and transmitting the message to the client STA.

Clause 11: The computer-implemented method of Clause 10, wherein the roaming prediction information further comprises, for each target AP, an indication of amount of time to return to the source AP.

Clause 12: The computer-implemented method according to any of Clauses 10-11, wherein: the one or more target APs are associated with a predicted roaming path for the client STA; and the roaming prediction information further comprises an indication of a roaming sequence among the one or more target APs for the client STA to follow for the predicted roaming path.

Clause 13: The computer-implemented method according to any of Clauses 10-12, wherein the one or more target APs are ranked according to a prediction of one or more performance metrics for the client STA when the client STA is associated with each respective target AP.

Clause 14: The computer-implemented method according to any of Clauses 10-13, wherein the roaming prediction information further comprises, for each target AP within the roaming sequence, a likelihood of the client STA returning to a previous target AP within the roaming sequence after roaming to the target AP.

Clause 15: The computer-implemented method according to any of Clauses 10-14, wherein the message is based at least in part on a basic service set (BSS) transition management (BTM) frame format.

Clause 16: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-9.

Clause 17: A non-transitory computer-readable medium comprising computer-executable code, which when executed by one or more processors of a computing device perform a method in accordance with any of Clauses 1-9.

Clause 18: An apparatus comprising means for performing a method in accordance with any of Clauses 1-9.

Clause 19: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 10-15.

Clause 20: A non-transitory computer-readable medium comprising computer-executable code, which when executed by one or more processors of a computing device perform a method in accordance with any of Clauses 10-15.

Clause 21: An apparatus comprising means for performing a method in accordance with any of Clauses 10-15.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for facilitating roaming of a client station (STA) within a wireless network, the computer-implemented method comprising:
determining one or more parameters associated with roaming activity of the client STA within the wireless network;
evaluating the one or more parameters with one or more machine learning (ML) models to determine a mobile classification associated with the client STA and roaming prediction information associated with the client STA; and
transmitting a message comprising the roaming prediction information and the mobile classification.

2. The computer-implemented method of claim 1, wherein the mobile classification indicates that the client STA is (i) a static client STA, (ii) a pacing client STA with a predictable pattern, or (iii) a mobile client STA lacking a predictable pattern.

3. The computer-implemented method of claim 1, wherein the one or more parameters comprise at least one of a signal strength of the client STA, a modulation and coding scheme (MCS) used at the client STA, traffic volume for one or more access categories (ACs), signal strength of probe requests, beacon reports, or any combination thereof.

4. The computer-implemented method of claim 1, wherein the one or more ML models comprises a ML model trained to predict a likelihood that the client STA is a static client STA.

5. The computer-implemented method of claim 1, wherein the one or more ML models comprises a ML model trained to predict a target access point (AP) for the client STA and a likelihood of the client STA returning to a previous source AP after roaming to the target AP.

6. The computer-implemented method of claim 1, wherein the one or more ML models comprises a ML model trained to predict, for at least one access point (AP) within the wireless network, a likelihood of the AP being a transient AP.

7. The computer-implemented method of claim 1, wherein the one or more ML models comprises a ML model trained to predict, for the client STA, a likelihood of a successful communication session with a source access point (AP) without roaming to a target AP.

8. The computer-implemented method of claim 1, wherein the roaming prediction information comprises an indication of (i) a target access point (AP) for the client STA to associate with within the wireless network and (ii) an indication of one or more other APs that the client STA should avoid roaming to within the wireless network.

9. The computer-implemented method of claim 8, wherein the target AP is associated with a predefined level of performance for a predetermined amount of time.

10. A computer-implemented method for facilitating roaming of a client station (STA) within a wireless network, the computer-implemented method comprising:
obtaining an indication of roaming prediction information and a mobile classification associated with the client STA;
generating a message comprising an indication of the roaming prediction information, based at least in part on the mobile classification, the roaming prediction information comprising an indication of (i) one or more target access points (APs) for the client STA and (ii) for each target AP of the one or more target APs, a likelihood of the client STA returning to a source AP after roaming to the target AP; and
transmitting the message to the client STA.

11. The computer-implemented method of claim 10, wherein the roaming prediction information further comprises, for each target AP, an indication of amount of time to return to the source AP.

12. The computer-implemented method of claim 10, wherein:
the one or more target APs are associated with a predicted roaming path for the client STA; and
the roaming prediction information further comprises an indication of a roaming sequence among the one or more target APs for the client STA to follow for the predicted roaming path.

13. The computer-implemented method of claim 12, wherein the one or more target APs are ranked according to a prediction of one or more performance metrics for the client STA when the client STA is associated with each respective target AP.

14. The computer-implemented method of claim 12, wherein the roaming prediction information further comprises, for each target AP within the roaming sequence, a likelihood of the client STA returning to a previous target AP within the roaming sequence after roaming to the target AP.

15. The computer-implemented method of claim 10, wherein the message is based at least in part on a basic service set (BSS) transition management (BTM) frame format.

16. A computing device comprising:
one or more memories collectively storing instructions; and
one or more processors communicatively coupled to the one or more memories, the one or more processors being individually or collectively configured to execute the instructions to cause the computing device to perform an operation comprising:
obtaining an indication of roaming prediction information and a mobile classification associated with a client station (STA);
generating a message comprising an indication of the roaming prediction information, based at least in part on the mobile classification, the roaming prediction information comprising an indication of (i) one or more target access points (APs) for the client STA and (ii) for each target AP of the one or more target APs, a likelihood of the client STA returning to a source AP after roaming to the target AP; and
transmitting the message to the client STA.

17. The computing device of claim 16, wherein the roaming prediction information further comprises, for each target AP, an indication of amount of time to return to the source AP.

18. The computing device of claim 16, wherein:
the one or more target APs are associated with a predicted roaming path for the client STA; and
the roaming prediction information further comprises an indication of a roaming sequence among the one or more target APs for the client STA to follow for the predicted roaming path.

19. The computing device of claim 18, wherein the one or more target APs are ranked according to a prediction of one or more performance metrics for the client STA when the client STA is associated with each respective target AP.

20. The computing device of claim 18, wherein the roaming prediction information further comprises, for each target AP within the roaming sequence, a likelihood of the client STA returning to a previous target AP within the roaming sequence after roaming to the target AP.
